(19) United States
(12) Patent Application Publication
(10) Pub. No.: US 2020/0074410 A1
(43) Pub. Date: Mar. 5, 2020

(54) Aircraft Certification System Based On A Distributed Public Ledger

(71) Applicant: THE BOEING COMPANY, Chicago, IL (US)

(72) Inventor: Joshua R. Binder, Seattle, WA (US)

(21) Appl. No.: 16/121,717

(22) Filed: Sep. 5, 2018

(51) Int. Cl. G06Q 10/00; H04L 9/32; H04L 9/06; G06F 17/30

(52) U.S. Cl. CPC G06Q 10/20; H04L 9/3252; H04L 2209/38; G06F 17/30194; H04L 9/0643; H04L 9/0637

(57) ABSTRACT

An airworthiness certification system employs a digital public ledger (DPL) that records compliance with all regulatory requirements that must be met to obtain and/or maintain airworthiness certification. When a user verifies compliance with a regulatory requirement, the user generates a digital compliance record containing certification data indicating compliance with the regulatory requirement and a cryptographic signature of the user. The digital compliance record is recorded in a digital public ledger by generating a new transaction block in the DPL containing the digital compliance record and cryptographically linking the transaction block with a previous transaction block in the DPL.

### TECHNOLOGICAL FIELD

The present disclosure relates generally to the field of airworthiness certification of aircraft and, more particular, to a distributed public ledger system for maintaining records related to airworthiness certification.

### BACKGROUND

Current commercial aircraft certification is structured to provide regulatory approval of a design (through Type Certification or Amended Type Certification), followed by regulatory approval of a particular aircraft under an approved design (Airworthiness Certification or Production Certification). Modifications of aircraft with an existing Type Certificate require a Supplemental Type Certificate, which is intended to incorporate by reference the existing Type Certificate.

The existing certification process was developed to provide certification of blocks of similar aircraft, as it was impractical at the time the system was developed to provide regulatory approval of the design and production features of individual aircraft. As this approach was developed to address large numbers of aircraft at once, it consequently results in high per-airplane costs whenever changes are made for a small number of aircraft. For example, a design update for an approved aircraft design may be too costly to incorporate if it impacts the Type Certificate for the aircraft and only a small number of units are planned for production. For products with uncertain or infrequent sales, the burden of obtaining a Supplemental Type Certification can mean that design updates are deferred for long periods because the incremental sales block may be insufficient to amortize the costs of re-certification. This delay in making design changes in turn tends to limit frequent design changes to “minor” updates that do not impact the Type Certificate, followed by infrequent “major” updates under an Amended Type Certificate. The existing certification process thus can prevent or delay useful product improvements from being delivered to the market for extended periods, and create unintended regulatory arbitrage opportunities between entities requesting Supplemental and Amended Type Certificates.

### SUMMARY

The present disclosure provides an airworthiness certification system for certifying the airworthiness of an aircraft. The airworthiness certification system employs a digital public ledger (DPL) that records compliance with all regulatory requirements that must be met to obtain and/or maintain airworthiness certification. When a user verifies compliance with a regulatory requirement, the user generates a digital compliance record containing certification data proving compliance with the regulatory requirement and a digital signature of the user. The user records the digital compliance record in a digital public ledger by generating a new transaction block in the DPL containing the digital compliance record and cryptographically linking the transaction block with a previous transaction block in the DPL.

The initial design and validation process for the aircraft builds out the beginning of the DPL for the aircraft by assembling corresponding transaction blocks into a blockchain. As production of the aircraft proceeds, each step in the manufacturing process (e.g., supplier delivery or job completion) creates a similar transaction (or block) in the chain by establishing the result of the process step meets the regulatory requirements. The addition of digital compliance records to the DPL is repeated for each process step for each aircraft produced. The certification basis for the aircraft is established by the complete chain of individual transactions throughout the design, validation, and production processes.

Changes can be made to the aircraft during maintenance, upgrade or modification without impacting the overall certification. Rather, the changes or modifications only need to satisfy the regulatory requirements impacted by the upgrade or modification. Following each upgrade or modification impacting the airworthiness certification, a new digital compliance record is generated and added to the DPL to show compliance with the regulatory requirements impacted by the upgrade or modification in the same manner as described above. The DPL accumulates blocks for each upgrade or modification on each aircraft until the aircraft is removed from service.

The airworthiness certification process as described above does not rely on distinctions between Type, Supplemental, Amended or Production Certificates and eliminates the unintended regulatory arbitrage opportunities among these certification methods. Instead, the airworthiness certification process relies on the public ledger transactions to individually and comprehensively establish the airworthiness of the aircraft. For the same reason, this process enables greater incremental change to aircraft in production or service, since the scope of the airworthiness certification impact is limited only to the elements of change.

The features, functions and advantages that have been discussed can be achieved independently in various aspects or can be combined in yet other aspects further details of which can be seen with reference to the following description and the drawings.

### BRIEF DESCRIPTION OF THE DRAWINGS

Having thus described variations of the disclosure in general terms, reference will now be made to the accompanying drawings, which are not necessarily drawn to scale, and wherein:

FIG. 1 illustrates an exemplary airworthiness certification system in accordance with an embodiment.

FIG. 2A illustrates a DPL for airworthiness certification of an aircraft according to an embodiment.

FIG. 2B illustrates a DPL for airworthiness certification of an aircraft according to an embodiment.

FIG. 3 illustrates a method of generating a digital compliance record for inclusion in a DPL for airworthiness certification of an aircraft or aircraft part in accordance with an embodiment.

FIG. 4 illustrates one example of a DPL for airworthiness certification of an aircraft or aircraft part in accordance with an embodiment.

FIG. 5 another method of generating a digital compliance record for inclusion in a DPL for airworthiness certification of an aircraft or aircraft part in accordance with an embodiment.

FIG. 6 illustrates another example of a DPL for airworthiness certification of an aircraft or aircraft part in accordance with an embodiment.

FIG. 7 is a flow diagram illustrating the roles of the various entities according to an embodiment of the airworthiness certification system.

FIG. 8A illustrates a method of adding digital compliance records for airworthiness certification to a DPL in accordance with an embodiment.

FIG. 8B illustrates a method implemented by a network node in a DPL network of adding digital compliance records to a DPL for airworthiness certification of an aircraft or aircraft part in accordance with an embodiment.

FIG. 9 illustrates a computing device for use in the airworthiness certification system in accordance with an embodiment.

### DETAILED DESCRIPTION

The embodiments described herein recognize and take into account that previous solutions for certifying aircraft focused on certifying blocks of aircraft of a common group. For example, a Type Certificate signifies the airworthiness of a particular category of aircraft and confirms that the aircraft is manufactured to an approved design, and that the design complies with airworthiness requirements. The embodiments described herein recognize and take into account that the previous solutions result in greater than desired costs for implementing changes in a small subset of aircraft. The solutions also enable production of parts for aircraft to be more closely tracked, making it more difficult to put unapproved aircraft parts into the supply stream used by aircraft manufacturers.

The solutions described herein for recording compliance with regulatory requirements for air worthiness certification do not rely on distinctions between Type, Supplemental, Amended or Production Certificates and eliminates the unintended regulatory arbitrage opportunities among these certification methods. A technical effect of the solutions described herein include reduced cost and complexity of certification of aircraft. The solutions enable changes or modifications to be made to a small number of aircraft without incurring high costs for airworthiness certification. The reduced regulatory burden in turn enables greater incremental change to aircraft in production or service, since the scope of the airworthiness certification impact is limited only to the regulatory requirements affected by the change.

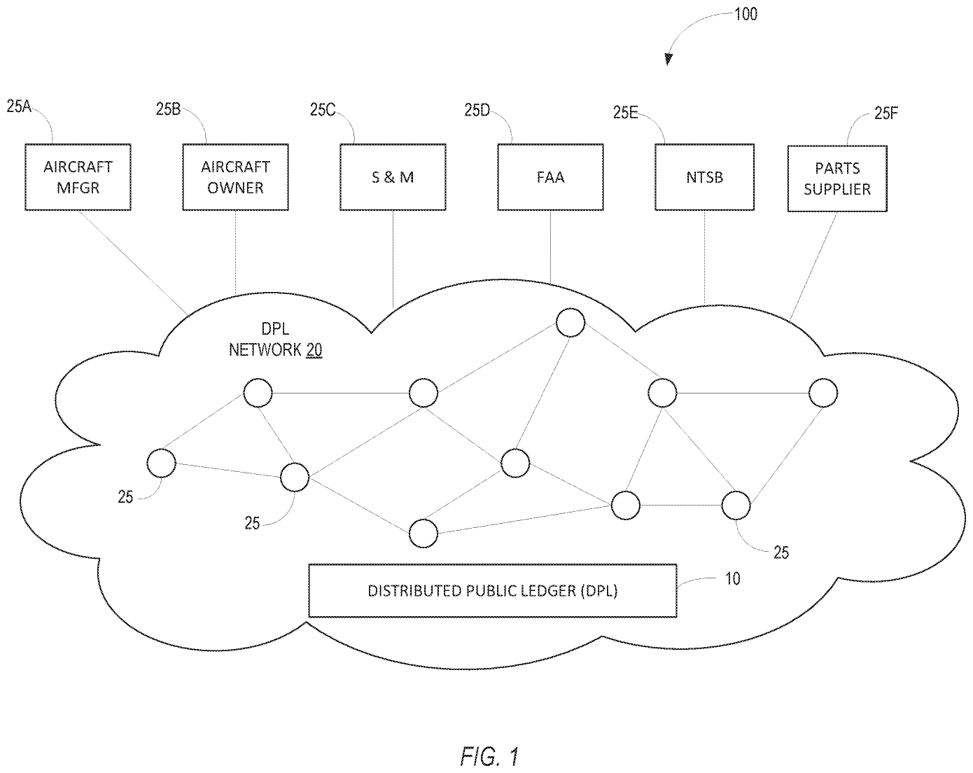

Referring now to the drawings in which similar reference numbers are used throughout the Figures to indicate similar elements, FIG. 1 illustrates an exemplary airworthiness certification system 100 based on a Distributed Public Ledger (DPL) 10 for records related to airworthiness certification for an aircraft. The DPL 10 comprises a record of all transactions or events that impact the airworthiness certification of an aircraft. The DPL 10 is shared, replicated and synchronized across a plurality of the network nodes 25 in a DPL network 20. There is no central administrator or central repository for data storage. This aspect provides greater security against removal or falsification of the data after it is stored in the DPL 10.

Each of the network nodes 25 in the DPL network 20 comprises a computing device capable of communicating with the other network nodes 25 in the DPL network 20, referred to herein as peer nodes. Each network node 25 in the DPL network 20 stores a copy of the DPL 10. Records are added to the DPL 10 by consensus of the network nodes 25

Network nodes 25A-25F, shown as attached to the DPL network 20, are associated with respective users of the DPL network 20. Typical users of the airworthiness certification system 100 comprise aircraft manufacturers, aircraft owners, maintenance and service organizations, parts suppliers, regulatory agencies such as the Federal Aviation Administration (FAA), investigative agencies such as the National Transportation safety Board (NTSB), members of the public, and the like. Each of the network nodes 25A-25F includes an Air Worthiness Certification (AWC) application for submitting certification records to the DPL network 20 for recordation in the DPL 10. One of the network nodes 25 can also function as an administrator of the DPL network 10. For example, network node 25D under the control of the FAA can be configured to function as an administrator of the DPL network 10. The administrator is responsible for user management, authentication, and authorization of other users of the DPL network 20. The administrator (e.g. network node 25D) stores user information needed for the operation of the air worthiness certification system 100. User information can include information such as user identification, user passwords, user addresses, user permissions and privileges, and pubic keys of the users. Users of the airworthiness certification system 100 can be required to register with the administrator and different users can have different permission levels. For example, an aircraft manufacturer can have permission to write to and read from the DPL 10, but members of the public can have permission only to read the DPL 10. As another example, some users (e.g., manufacturers) can be given permission to create a new DPL 10 for a particular aircraft or group of aircrafts. For example, a user may start a new DPL 10 for each aircraft produced. The administrator handles registration of users and assignment of permissions to the users, and communicates with other network nodes 25 to provide relevant user information (e.g., user identification, permissions, public keys, etc.)

The airworthiness certification system 100 can be used to implement a new process for airworthiness certification that obviates the need for the current Type Certificate/Production Certificate model. Before further describing the details of the airworthiness certification system 100, a brief example is given here to provide context for understanding the disclosure. Assume that an aircraft manufacturer desires to certify the airworthiness of a new aircraft. In this example, it is assumed that the aircraft to be certified is the first of its kind and that a DPL 10 has been created for the aircraft. The Applicant (e.g., the manufacturer) defines the Methods of Compliance used to satisfy regulatory requirements consistent with current practice. The complete set of the Methods of Compliance establish the standards for approving the airworthiness of the aircraft. Following each instance of a regulatory requirement being satisfied (e.g., an approved engineering analysis, completed validation test, etc.), the Applicant generates a transaction record, referred to herein as a digital compliance record, to be included in a DPL 10 for the aircraft. In one example, each digital compliance record contains the regulatory requirement, the compliance data satisfying the regulatory requirement, a digital timestamp, and a signature of the party asserting the compliance. The Applicant submits the digital compliance record to the DPL subsystem 30 for recordation in the DPL 10. After the digital compliance record is validated (e.g., by consensus of the network nodes 25 in the DPL network 20), the digital compliance record (represented by a new transaction block in a blockchain) is added to the DPL 10. The new transaction block includes an encryption key (or hash) linking the new transaction block to other transaction blocks in the aircraft's chain verification to form a blockchain.

The initial design and validation process for the aircraft builds out the beginning of the DPL 10 for the aircraft by assembling the transaction blocks described above into a blockchain. As production of the aircraft proceeds, each step in the manufacturing process (e.g., supplier delivery or job completion) creates a similar transaction block in the blockchain by establishing the result of the process step meets the standards established by the declared Methods of Compliance. The addition of digital compliance records to the DPL 10 is repeated for each process step for each aircraft produced. The certification basis for the aircraft is established by the complete chain of individual transactions throughout the design, validation, and production processes. When all of the regulatory requirements are satisfied, the aircraft is deemed airworthy. In this way, the certification basis is a chain of individual transactions (blocks), rather than an aggregated collection of events.

Changes can be made to the aircraft during maintenance, upgrade or modification without impacting the overall certification. Rather, the changes or modifications only need to satisfy the regulatory requirements impacted by the upgrade or modification. Following each upgrade or modification impacting the airworthiness certification, a new digital compliance record is generated and added to the DPL 10 to show compliance with the regulatory requirements impacted by the upgrade or modification in the same manner as described above. The DPL 10 accumulates transaction blocks for each upgrade or modification on each aircraft until the aircraft is removed from service.

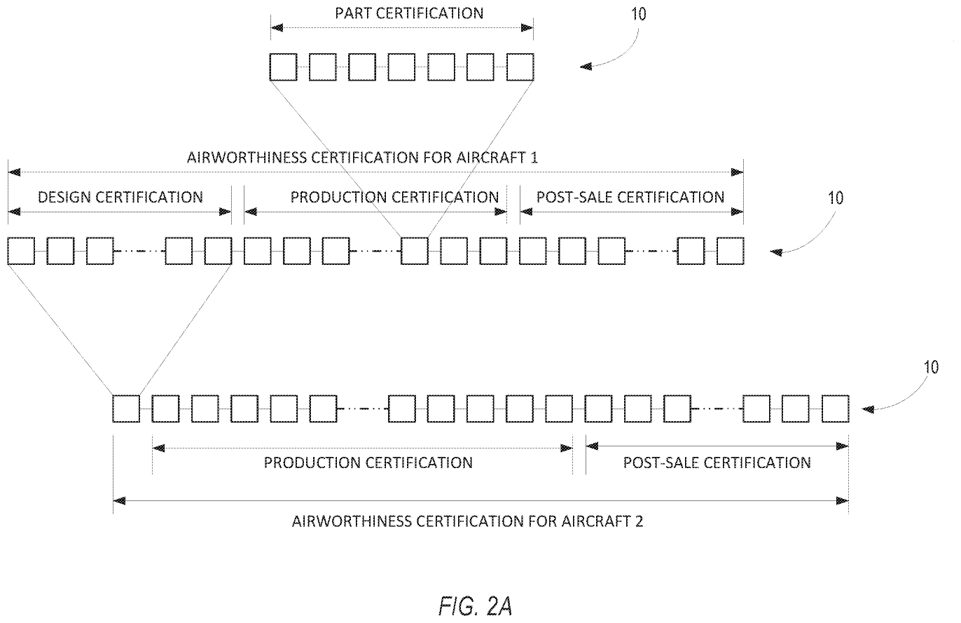

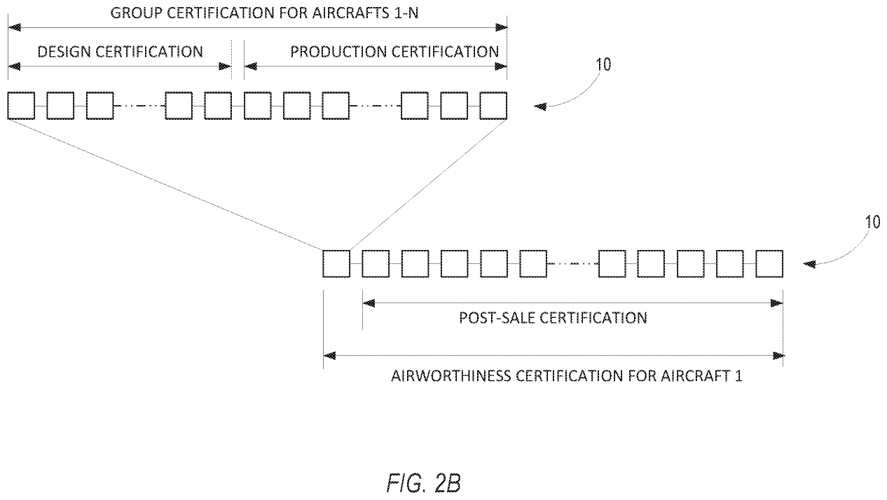

FIG. 2A illustrates how DPLs 10 can be used in one embodiment to implement the airworthiness certification system. FIG. 2A illustrates three DPLs 10; a DPL 10A for certification of an aircraft part, a DPL 10B for the certification of Aircraft 1, and DPL 10C for the certification of Aircraft 2. As previously noted, each DPL 10A, 10B, and 10C is implemented by a blockchain comprising a series of transactions that collectively provide the basis for airworthiness certification. DPL 10A comprises the transactions for airworthiness certification of an aircraft part. DPL 10B comprises the transactions for airworthiness certification of Aircraft 1. DPL 10C comprises the transactions for certification airworthiness certification of Aircraft 2. DPLs 10B and 10C show transactions for Aircraft 1 and Aircraft 2 from the initial design, thru production, and post-sale until the aircraft is removed from service. In the example shown in FIG. 2A, the certification record for Aircraft 1 includes all transactions needed to certify the aircraft design. Also, the part certification represented by DPL 10A is incorporated into the airworthiness certification of Aircraft 1 as a single transaction. In a similar fashion, the transactions related to the certification of the aircraft design in DPL 10B comprise a single transaction in the airworthiness certification record for Aircraft 2, which is assumed to be of the same type as Aircraft 1. This example illustrates how a blockchain or DPL 10 can be incorporated into another blockchain or DPL 10 as a single transaction.

FIG. 2B illustrates another example of how DPLs 10 can be used to implement the airworthiness certification system 100. FIG. 2B illustrates two DPLs 10; a DPL 10D for certifying a group of aircraft through production, and a DPL 10E for certifying the airworthiness of an individual aircraft after sale. DPL 10D, and DPL 10E are implemented by a blockchain comprising a series of transactions that collectively provide the basis for airworthiness certification. DPL 10D comprises the transactions for airworthiness certification of a group of aircraft through the end of production. Those skilled in the art will appreciate that the transactions in DPL 10D related to the aircraft design could, alternatively, be in a separate ledger (not shown) and incorporated into DPL 10D as a single transaction as shown in FIG. 2A. DPL 10E comprises the transactions for airworthiness certification of Aircraft 1 occurring after the sale of Aircraft 1. In this example, the initial transaction in DPL 10E records the sale of Aircraft 1 to a buyer and incorporates DPL 10D. Subsequent transactions in DPL 10E record transaction related to service and maintenance of Aircraft 1, and upgrades or modifications to Aircraft 1.

The airworthiness certification process as described above does not rely on distinctions between Type, Supplemental, Amended or Production Certificates and eliminates the unintended regulatory arbitrage opportunities among these certification methods. Instead, this airworthiness certification process relies on the public ledger transactions to individually and comprehensively establish the airworthiness of the aircraft. For the same reason, this process enables greater incremental change to aircraft in production or service, since the scope of the airworthiness certification impact is limited only to the elements of change.

The airworthiness certification process also enables closer tracking of the supply of aircraft parts. Using the solutions described herein, each parts supplier can be required to certify every unit produced and each unit produced can be individually tracked. Thus, it will be more difficult for unapproved parts to enter into the supply chain. The part can be certified when the part is initially produced and each transfer of the part can be recorded in a DPL 10. The certification of the part can then be included in the overall airworthiness certification record.

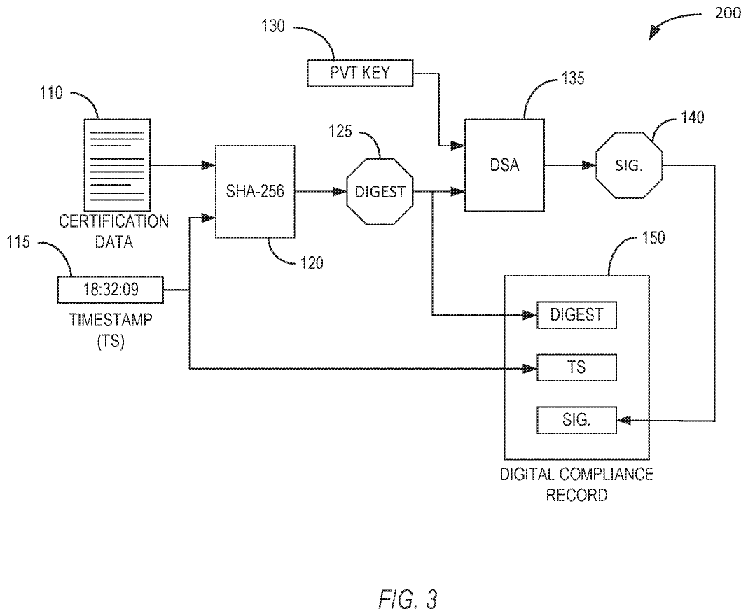

FIG. 3 illustrates a process 200 for creating a digital compliance record, denoted generally by the numeral 150, to be included in the DPL 10. The process 200 is typically performed by a network node 25 in the DPL network 20 under the control of an authorized user. For example, the process 200 can be implemented by any one of network nodes 25A-25F. It is assumed in this example that DPL 10 is a permissioned public ledger, that the user is registered with the administrator, and that the user has been granted permission to add records to the DPL 10 for the aircraft. The network node 25 obtains certification data 110 indicating compliance with a regulatory requirement for airworthiness certification. The certification data 110 can include, for example, the regulatory requirement, the Method of Compliance associated with the regulatory requirement, and compliance data satisfying the Method of Compliance for the regulatory requirement. For example, the Method of Compliance may include the method by which compliance is shown (e.g., analysis, structural test, ground test, flight test, and the like). Other information can also be included in the certification data 110. The certification data 110 and a digital timestamp 115 are input to a one-way hash function 120 to generate a message digest 125. The digital timestamp 115 can be obtained from a trusted time-stamping authority to prevent falsification of the digital timestamp. As one example, the one-way hash function 120 could comprise an implementation of a 256-bit Secure Hash Algorithm (SHA-256) algorithm. The output of the one-way hash function 120 comprises a message digest 125 that can be used to prove that the certification data 110 existed as of the date of the digital timestamp 115.

The message digest 125 and digital timestamp 115 comprise two elements of the digital compliance record 150. Including the message digest 125 in the digital compliance record 150 rather than a plaintext record enables the user to prove an assertion of compliance without disclosing to the public the underlying data proving the claim. In the event that the assertion of compliance is challenged by a third party, the user can produce the original certification data 110 and the digital timestamp 110 used to generate the message digest 125. The third party can verify the assertion of compliance by generating a hash using the original certification data 110 and the digital timestamp 115 as input, and comparing the generated hash to the message digest 125. If the generated hash matches the message digest 125, the digital compliance record 150 is authenticated as the basis for the assertion of compliance.

The message digest 125 along with a private key 130 of the user is input to a signature function 135. The private key 130 is part of a key pair including the private key 130 and a corresponding public key (not shown). The signature function 135 encrypts the message digest 125 with the private key 130 of the user to generate a cryptographic signature 140 on the message digest 125. The cryptographic signature 140 is included in the digital compliance record 150 to prove the identity of the user asserting compliance, i.e., the user that submits the digital compliance record 150 to the DPL 10. To prove the identity of the user asserting compliance, the public key of the user can be used to decrypt the cryptographic signature 140 to obtain the decrypted signature. The decrypted signature can then be compared to the actual message digest 125 contained in the digital compliance record 150 and, if they are a match, the identity of the user is proven. Exemplary signing algorithms suitable for use in the present disclosure include the Digital Signature Algorithm (DSA) and the Elliptic Curve DSA (ECDSA).

The digital compliance record 150 in this example comprises the message digest 125, digital timestamp 115 and cryptographic signature 140 of the user. The message digest 125 is used to authenticate the certification data 110 that proves compliance with a regulatory requirement. The digital timestamp 115 proves existence of the data as of the date of the digital timestamp 115. The cryptographic signature 140 proves the identity of the user asserting the compliance. This record is then submitted by the user to the DPL network 20 for recordation in the DPL 10 for the aircraft. Other information can be included in the digital compliance record 150, or provided to the DPL 10 along with the digital compliance record 150. For example, an identifer that uniquely identifies a DPL 10 to which the digital compliance record 150 is being added can be included in or provided along with the digital compliance record 150. The identifer can be associated with a single aircraft, a group of aircraft, an aircraft part, or a group of aircraft parts.

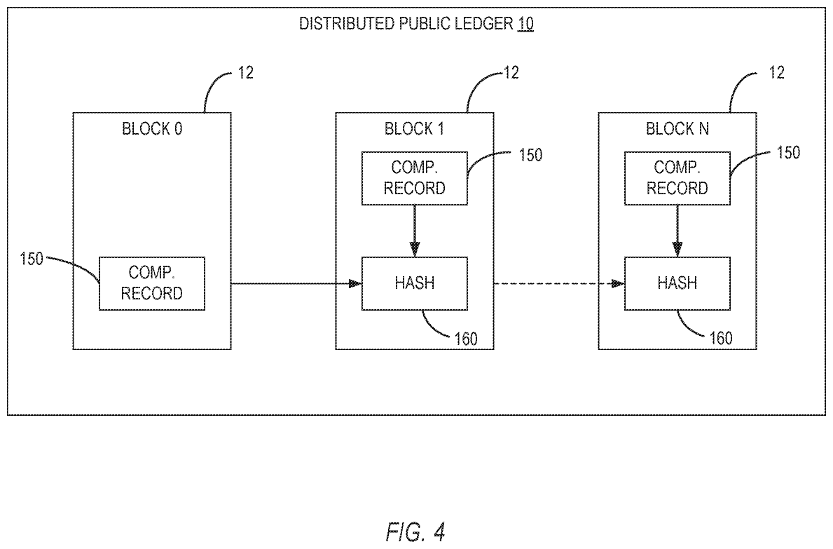

FIG. 4 illustrates one example of a DPL 10 for an aircraft based on the digital compliance record generated by the process 200 shown in FIG. 3. As previously noted, the DPL 10 comprises a blockchain, where each transaction block 12 corresponds to one transaction, i.e. an assertion of compliance. FIG. 4 illustrates a DPL 10 comprising N transaction blocks 12 denoted as Block 0-Block N. Block 0, referred to as the genesis block, contains the first digital compliance record 150. As previously noted, the genesis block for a DPL 10 could incorporate another blockchain or DPL 10 as a single transaction. For example, the genesis block can incorporate another blockchain or DPL 10 containing transactions related to the certification of an aircraft design, or to the certification of a group of aircraft. Each subsequent transaction block 12 contains an additional digital compliance record 150 along with a cryptographic link to the previous transaction block 12. As shown in FIG. 4, the cryptographic link comprises a hash generated by a one-way hash function using the previous transaction block 12 and the new digital compliance record 150 as inputs. As one example, the one-way hash function could comprise an implementation of the SHA-256 algorithm. Adding the digital compliance record 150 to the DPL 10 for the aircraft makes the digital compliance record 150 immutable. Once added to the DPL 10, the digital compliance record 150 cannot be altered or deleted and will remain a permanent part of the airworthiness certification for the aircraft.

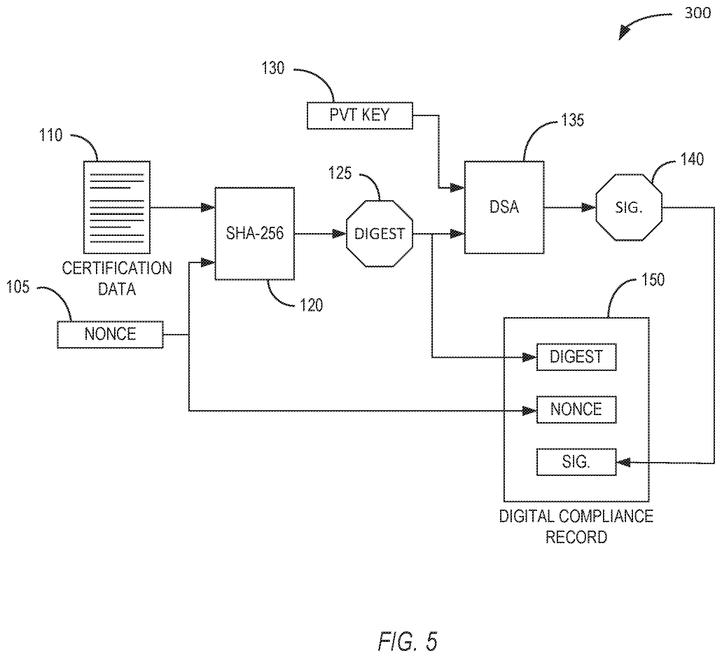

FIG. 5 illustrates another process 300 for creating a digital compliance record 150 to be included in the DPL 10. The process 300 shown in FIG. 5 is the same as the process 200 shown in FIG. 3 with the exception of a nonce 105 being used in place of the digital timestamp 115. As described in more detail below, a digital timestamp 170 is generated when the digital compliance record 150 is added to the DPL 10.

The process 300 is typically performed by a network node 25 in the DPL network 20 under the control of an authorized user such as an aircraft manufacturer, aircraft owner, or service and maintenance organization. It is assumed that the DPL 10 is a permissioned public ledger, that the user is registered with the administrator, and that the user has been granted permission to add records to the DPL 10 for the aircraft. The network node 25 obtains certification data 110 indicating compliance with a regulatory requirement for airworthiness certificate. The certification data 110 can include, for example, the regulatory requirement, the Method of Compliance associated with the regulatory requirement, and compliance data satisfying the Method of Compliance for the regulatory requirement. Other information can also be included in the certification data 110. The certification data 110 and a nonce 105 are input to a one-way hash function 120 to generate a message digest 125. The nonce 105 can be obtained from a random number generator. As one example, the one-way hash function 120 could comprise an implementation of the SHA-256 algorithm. The output of the one-way hash function 120 comprises a message digest 125. The message digest 125 and nonce 105 comprise two elements of the digital compliance record 150.

The message digest 125 along with a private key 130 of the user is input to a signature function 135. The private key 130 is part of a key pair including the private key 130 and a corresponding public key (not shown). The signature function 135 encrypts the message digest 125 with the private key 130 of the user to generate a cryptographic signature 140 on the message digest 125. The cryptographic signature 140 is included in the digital compliance record 150 to prove the identity of the user asserting compliance, i.e., the user that submits the digital compliance record 150 to the DPL 10. To prove the identity of the user asserting compliance, the public key of the user can be used to decrypt the cryptographic signature 140 to obtain the decrypted signature. The decrypted signature can then be compared to the actual message digest 125 contained in the digital compliance record 150 and, if they are a match, the identity of the user is proven. Exemplary signing algorithms suitable for use in the present disclosure include the Digital Signature Algorithm (DSA) and the elliptic curve DSA (ECDSA).

The digital compliance record 150 in this example comprises the message digest 125, nonce 105, and cryptographic signature 140 of the user. The message digest 125 and nonce 105 are used to authenticate the certification data 110 that proves compliance with a regulatory requirement. The cryptographic signature 140 proves the identity of the user asserting the compliance. This record is then submitted by the user to the DPL network 20 for recordation in the DPL 10 for the aircraft.

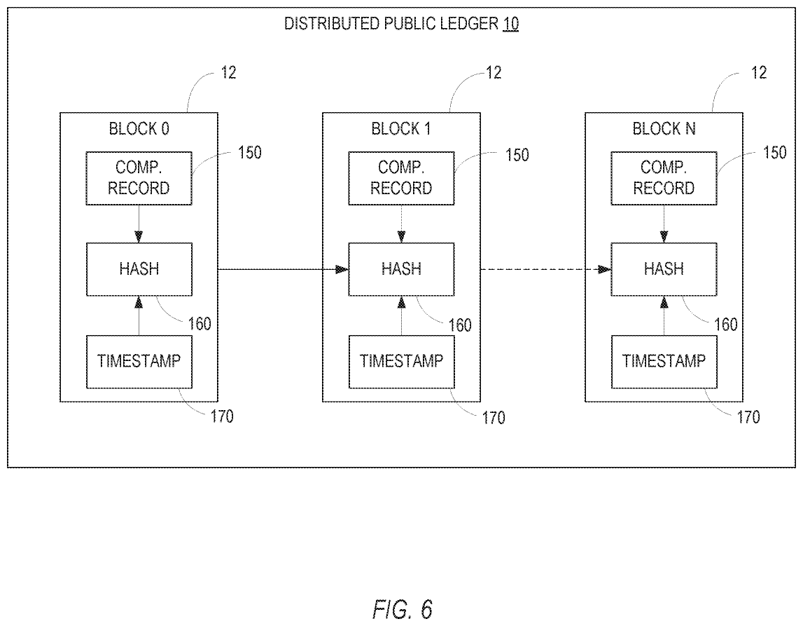

FIG. 6 illustrates another example of a DPL 10 for an aircraft based on the digital compliance record 150 generated by the process 300 shown in FIG. 5. As previously noted, the DPL 10 comprises a blockchain, where each transaction block 12 corresponds to one transaction, e.g., an assertion of compliance. FIG. 6 illustrates a DPL 10 comprising N transaction blocks 12 denoted as Block 0-Block N. Block 0, referred to as the genesis block contains the first digital compliance record 150, a digital timestamp 170 and a hash 160 generated by a one-way hash function using the first digital compliance record 150 and the digital timestamp 170. In this example, the presence of the hash 160 in the genesis block prevents alteration of the digital timestamp 170 without detection. Each subsequent transaction block 12 contains an additional digital compliance record 150 along with a cryptographic link to the previous transaction block 12. As shown in FIG. 6, the cryptographic link comprises a hash generated by a one-way hash function using the previous transaction block 12, the new digital compliance record 150 and a digital timestamp 170 as inputs. As one example, the one-way hash function could comprise an implementation of the SHA-256 algorithm. Adding the digital compliance record 150 to the DPL 10 for the aircraft makes the digital compliance record 150 immutable. Once added to the DPL 10, the digital compliance record 150 cannot be altered or deleted and will remain a permanent part of the airworthiness certification for the aircraft.

As noted in the discussion of FIG. 1, the network nodes 25 in the DPL network 20 maintain the DPL 10 for an aircraft in a distributed manner. When a new digital compliance record 150 is submitted by a user via the DPL subsystem 30, the new digital compliance record 150 needs to be validated before it is added to the DPL 10 to prevent a malicious third party from corrupting the DPL 10 or blocking the addition of new digital compliance records to the DPL 10. In some variations, the addition of the new digital compliance record to the DPL 10 is validated by consensus of the network nodes 25 in the DPL network 20. Each network node 25 authenticates the user who is asserting compliance by decrypting the cryptographic signature 140 contained in the digital compliance record 150 and comparing the decrypted signature with the message digest 125. If the decrypted signature matches the message digest 125, the user is authenticated and the network node 25 broadcasts its “vote” to its peer nodes. A network node 25 updates the DPL 10 when it receives votes from its peer nodes representing a predetermined percentage of the total number of network nodes 25 (e.g. 50%). Other consensus mechanisms could also be used.

Validation of the digital compliance record 150 could rely on other information in the digital compliance record 150. In the examples illustrated by FIGS. 3 and 4, the network nodes 25 may also verify that the digital timestamp 115 is trusted and/or that the digital timestamp 115 is not stale. As one example, the network node 25 can compute an age of the digital compliance record 150 based on the digital timestamp 115 and can reject any digital compliance record 150 that is beyond a predetermined age, e.g. 10 minutes. Also, if the digital timestamp 115 originates from a trusted digital timestamping authority, the network node 25 can authenticate the digital timestamp 115 using a public key of the digital timestamping authority. In this case, the signature of the digital timestamping authority can also need to be included in the digital compliance record 150.

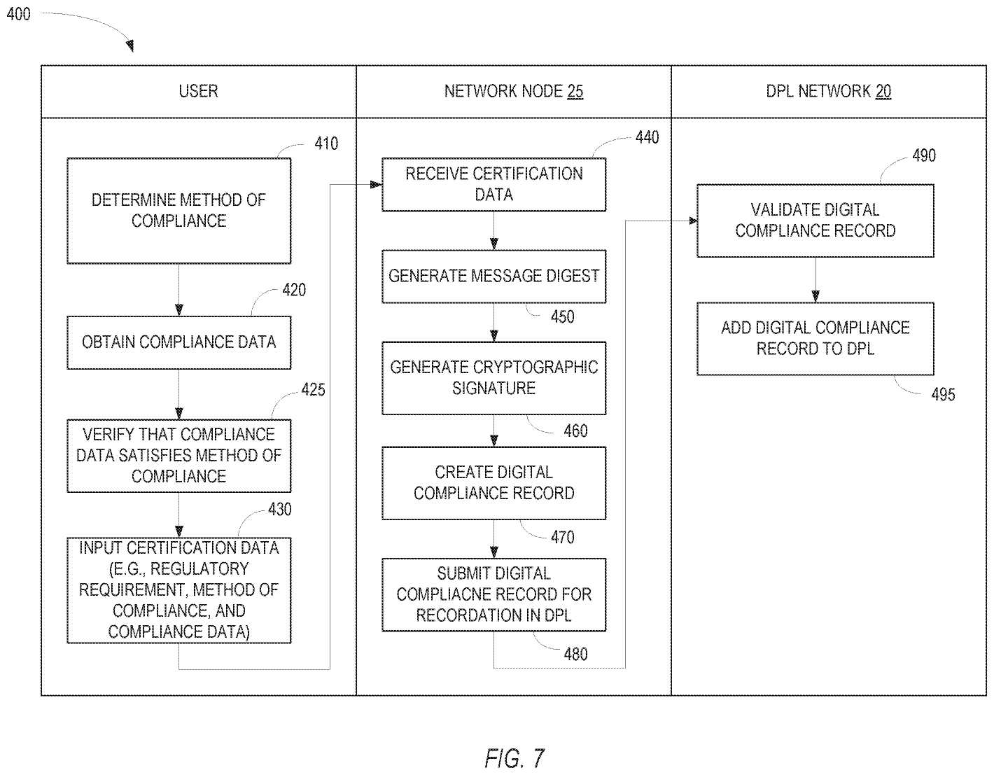

FIG. 7 is a flow diagram illustrating a exemplary method 400 of recording airworthiness certification records in a DPL 10 and the roles of various entities according to one embodiment of the airworthiness certification system 100. The method 400 shown in FIG. 7 involves three entities: a user, a first network node 25 to generate the digital compliance record 150, and the DPL network 20 comprising a plurality of second network nodes 25 to record the digital compliance record in the DPL 10. The user defines a Method of Compliance for proving compliance with a regulatory requirement (block 410). The user obtains data, referred to herein as compliance data, and determines that the compliance data satisfies the regulatory requirement (blocks 420, 425). The user inputs or otherwise provides certification data 110 to the first network node 25 in the airworthiness certification associated with a user (block 430). The certification data 110 can comprise the regulatory requirement, a Method of Compliance for satisfying the regulatory requirement, and compliance data satisfying the Method of Compliance. The compliance data can comprise, for example engineering analysis, test data, or similar information. Other information relevant to the compliance can also be included in the certification data 110. As one example, the certification data 110 may include an explicit indication that the compliance data satisfies the Method of Compliance for the regulatory requirement. Alternatively, the first network node 25 may generate the compliance indication in an embodiment.

The first network node 25 in the airworthiness certification system 100 associated with the user obtains, from the user, the certification data 110 indicating compliance with a regulatory requirement for airworthiness certification (block 440). The certification data 110 can be received by one of the first network node 25 from another computing device under the control of the user, or via direct user input, or some combination thereof. After obtaining the certification data 110, the first network node 25 generates a message digest 125 from the certification data 110 and a digital timestamp 115 as shown in FIG. 3 or a nonce 105 as shown in FIG. 5 (block 450). The first network node 25 then generates a cryptographic signature 140 on the message digest 125 (block 460). The first network node 25 combines the message digest 125, cryptographic signature 140 and timestamp 115 or nonce 105 to create a digital compliance record. The first network node 25 then submits the digital compliance record 150 to the DPL 10 for recordation in a DPL 10 for an aircraft, group of aircrafts, aircraft part, or group of aircraft parts (blocks 470, 480). The digital compliance record 150 may include other information, such as identifier of the DPL 10 to which the digital compliance record is being added. Alternatively, the identifier can be provided to the DPL network 20 along with the digital compliance record 150. The identifier can be associated with an aircraft, a group of aircraft, an aircraft part, or a group of aircraft parts, for which compliance with the regulatory requirement is being asserted. Upon receipt of the digital compliance record 150, the second network nodes 25 in the DPL network 20 validate the digital compliance record (block 490) and append the digital compliance record 150 to the DPL 10 as previously described (block 495)

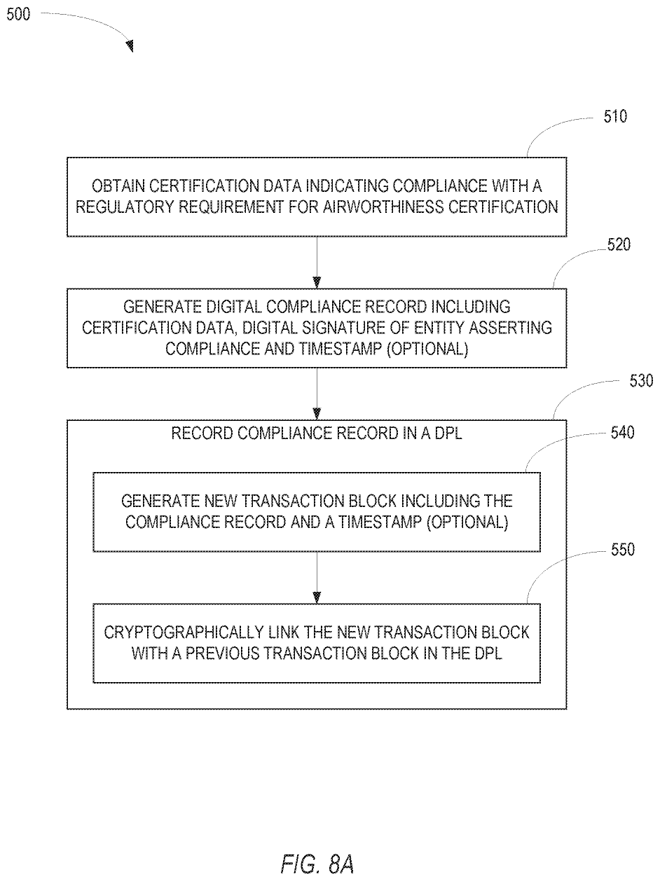

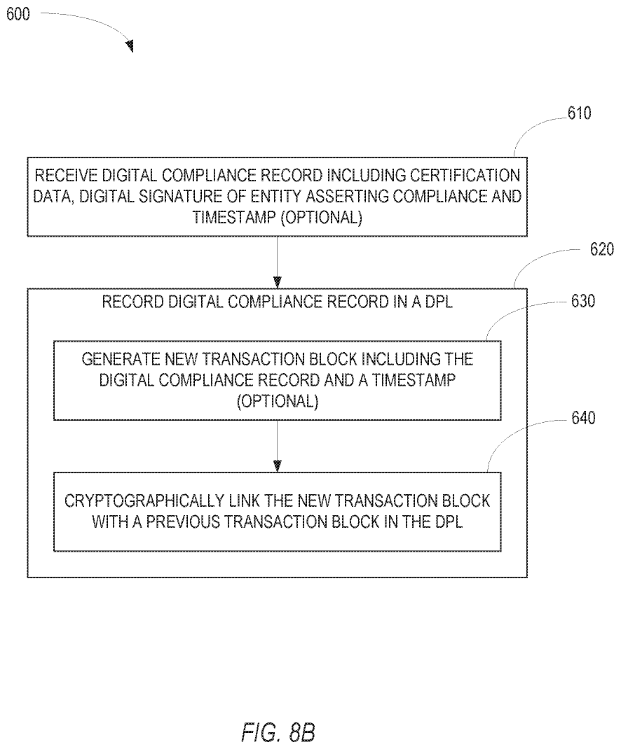

FIG. 8A illustrates an exemplary method 500 for adding records to a DPL 10, which stores a history of compliance with regulatory requirements as hereinabove described. Each time a regulatory requirement is satisfied, a new record is added to the DPL 10. The complete record for airworthiness certification shows compliance with all regulatory requirements.

The method 500 begins when a first network node 25 in the airworthiness certification system 100 associated with a user obtains certification data 110 indicating compliance with a regulatory requirement for airworthiness certification (block 510). The certification data 110 can comprise the regulatory requirement, a Method of Compliance for satisfying the regulatory requirement, and compliance data satisfying the Method of Compliance. The compliance data can comprise, for example engineering analysis, test data, or similar information. Other information relevant to the compliance can also be included in the certification data 110. As one example, the certification data may include an explicit indication that the compliance data satisfies the Method of Compliance for the regulatory requirement. The certification data 110 can be received by the network node 25 from another computing device, or via user input, or some combination thereof.

After obtaining the certification data, the first network node 25 generates a digital compliance record 150 including the certification data 110 and the cryptographic signature 140 of the entity certifying compliance (block 520). The first network node 25 can be configured to generate the digital compliance record 150 according to one of the processes 200, 300 shown in FIGS. 3 and 5 respectively. In some variations, generating the digital compliance record 150 comprises generating a message digest 125 from the certification data 110 and a digital timestamp 115, generating a cryptographic signature 140 using the message digest 125 and a private key 130 of an entity asserting compliance, and combining the message digest 125, digital timestamp 115 and cryptographic signature 140 to create the digital compliance record 150. In other variations, generating a digital compliance record 150 comprises generating a message digest 125 from the certification data 110, generating a cryptographic signature 140 using the message digest 125 and a private key 130 of an entity asserting the compliance, and combining the message digest 125 and cryptographic signature 140 to create the digital compliance record 150. The first network node 25 submits the compliance record to the DPL network 20 for recordation in the DPL 10.

The second network nodes 25 in the DPL network 20 record the digital compliance record 150 generated by the first network node 25 in a DPL 10 containing the complete compliance history for the aircraft (block 530). The second network nodes 25 can comprise a superset that includes the first network node 25. Recording the digital compliance record in the DPL 10 comprises generating a new transaction block 12 including the digital compliance record 150 (block 540). The new transaction block 12 is then cryptographically linked to a previous transaction block 12 in the DPL 10 (block 550). In some variations, cryptographically linking the new transaction block 12 with a previous transaction block 12 comprises generating a hash using the previous transaction block 12 and the new digital compliance record 150. In other variations, cryptographically linking the new transaction block 12 with a previous transaction block 12 in the DPL 10 comprises generating a hash using the previous transaction block 12, the digital compliance record 150, and a digital timestamp 170.

FIG. 8B illustrates a method 600 performed by the second network nodes 25 in the DPL network 20. The second network nodes 25 receive a digital compliance record 150 including certification data 110 evidencing compliance with the regulatory requirement and a cryptographic signature 140 of an entity asserting compliance (block 610). In some variations, the digital compliance record 150 comprises a digital timestamp 115, message digest 125 generated from the certification data 110 and the digital timestamp 115, and a cryptographic signature 140 generated using the message digest 125 and a private key 130 of an entity asserting compliance. In other variations, the digital compliance record 150 comprises a nonce 105, a message digest 125 generated from the certification data 110 and the nonce 105, and a cryptographic signature 140 generated using the message digest 125 and a privately of the an entity asserting compliance.

Responsive to the receipt of the digital compliance record 150, the second network nodes 25 in the DPL network 20 record the digital compliance record 150 generated by the network node 25 in a DPL 10 containing the complete compliance history for the aircraft (block 620). Recording the digital compliance record in the DPL 10 comprises generating a new transaction block 12 including the digital compliance record 150 (block 630). The new transaction block 12 is then cryptographically linked to a previous transaction block 12 in the DPL 10 (block 640). In some variations, cryptographically linking the new transaction block 12 with a previous transaction block 12 comprises generating a hash using the previous transaction block 12 and the new digital compliance record 150. In other variations, cryptographically linking the new transaction block 12 with a previous transaction block 12 in the DPL 10 comprises generating a hash using the previous transaction block 12, the digital compliance record 150, and a digital timestamp 170.

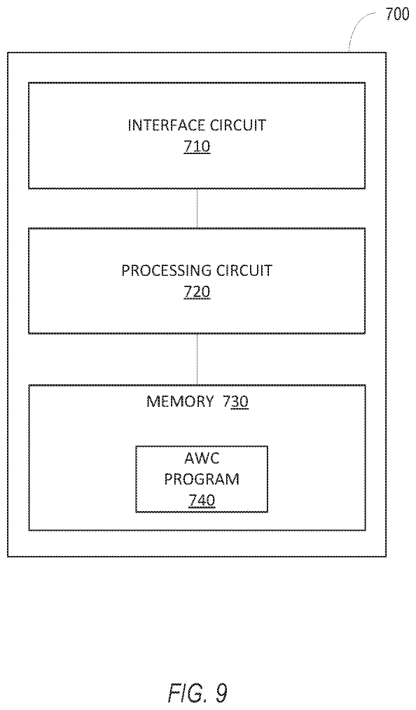

FIG. 9 illustrates a computing device 700 that can be configured to function as a network node 25 in the DPL network 20. The computing device 700 comprises an interface circuit 710, a processing circuit 720, and memory 730. The interface circuit 710 comprises circuitry for connecting the computing device 700 to a communication network to enable the computing device 700 to communicate with other computing devices over a communication network. The interface circuit 710 may comprise one or more of a wired interface (e.g. Ethernet), a wireless interface (e.g. cellular interface) or optical interface (e.g. Sonnet).

The processing circuit 720 controls the operation of the computing device 700. The processing circuit 720 executes an AWC application 740 that implements the methods herein described. The processing circuit 720 may comprise one or more microprocessors, hardware circuits, firmware, or a combination thereof.

Memory 730 comprises both volatile and non-volatile memory for storing computer program code and data needed by the processing circuit 720 for operation. Memory 730 may comprise any tangible, non-transitory computer readable storage medium for storing data including electronic, magnetic, optical, electromagnetic or semiconductor data storage. In general, computer program instructions and configuration information are stored in a non-volatile memory, such as a read only memory (ROM), erasable programmable ROM (EPROM) or flash memory. Temporary data generated during operation may be stored in a volatile memory, such as a random access memory (RAM).

Memory 730 stores the AWC application 740 that configures the computing device 700 to perform the AWC functionality as described herein. The AWC application 740 comprises executable program instructions that, when executed by the processing circuit 720 in the computing device 700, causes the computing device 700 to implement the methods herein described. In some variations, the AWC application 740 for configuring the processing circuit 720 as herein described may be stored in a removable memory, such as a portable compact disc, portable video digital disc, or other removable media. The AWC application 740 may also be embodied in a carrier such as an electronic signal, optical signal, radio signal, or computer readable storage medium.

The airworthiness certification system 100 as described above does not rely on distinctions between Type, Supplemental, Amended or Production Certificates and eliminates the unintended regulatory arbitrage opportunities among these certification methods. Instead, the airworthiness certification system 100 relies on the public ledger transactions to individually and comprehensively establish the airworthiness of the aircraft. For the same reason, this process enables greater incremental change to aircraft in production or service, since the scope of the Airworthiness Certification impact is limited only to the elements of change.

The present invention can, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of recording compliance with regulatory requirements for airworthiness certification of an aircraft or aircraft part, said method comprising:
obtaining certification data indicating compliance with a regulatory requirement for airworthiness certification;
generating a digital compliance record including the certification data; and
recording the digital compliance record in a distributed public ledger containing a compliance history for the aircraft or aircraft part.

2. The method of claim 1 wherein the certification data comprises the regulatory requirement, a Method of Compliance for meeting the regulatory requirement, and compliance data satisfying the Method of Compliance.

3. The method of claim 2 wherein generating the digital compliance record comprises:
generating a message digest from the certification data and a digital timestamp;
generating a cryptographic signature using the message digest and a private key of an entity asserting the compliance; and
combining the message digest, digital timestamp and cryptographic signature to create the digital compliance record.

4. The method of claim 2 wherein generating the digital compliance record comprises:
generating a message digest from the certification data;
generating a cryptographic signature using the message digest and a private key of an entity asserting the compliance;
combining the message digest and cryptographic signature to create the digital compliance record.

5. The method of claim 2 wherein recording the digital compliance record in the distributed public ledger comprises:
generating a new transaction block including the digital compliance record; and
cryptographically linking the new transaction block with a previous transaction block in the distributed public ledger.

6. The method of claim 5 wherein cryptographically linking the new transaction block with the previous transaction block comprises:
generating a hash of the previous transaction block and the digital compliance record; and
recording the hash in the new transaction block to cryptographically link the new transaction block with the previous transaction block in the distributed public ledger.

7. The method of claim 2 wherein recording the digital compliance record in the distributed public ledger comprises:
generating a new transaction block including the digital compliance record and a digital timestamp; and
cryptographically linking the new transaction block with a previous transaction block in the distributed public ledger.

8. The method of claim 7 wherein cryptographically linking the transaction block with the previous digital compliance record comprises:
generating a hash of the previous transaction block, the digital compliance record and the digital timestamp; and
recording the hash in the new transaction block to cryptographically link the new transaction block with a previous transaction block in the distributed public ledger.

9. An airworthiness certification system for recording compliance with regulatory requirements for airworthiness certification of an aircraft or aircraft part, said air worthiness certification system comprising:
a first network node configured to:
receive certification data indicating compliance with a regulatory requirement for airworthiness certification;
generate a digital compliance record including the certification data; and
a DPL network comprising a plurality of second network nodes configured to record the digital compliance record in a distributed public ledger containing a compliance history for the aircraft or aircraft part.

10. The airworthiness certification system of claim 9 wherein the certification data comprises the regulatory requirement, a Method of Compliance for meeting the regulatory requirement, and compliance data satisfying the Method of Compliance.

11. The airworthiness certification system of claim 9 the first network node is further configured to:
generate a message digest from the certification data and a digital timestamp;
generate a cryptographic signature using the message digest and a private key of an entity asserting the compliance;
combine the message digest, digital timestamp and cryptographic signature to create the digital compliance record.

12. The airworthiness certification system of claim 9 wherein the first network node is further configured to:
generate a message digest from the certification data;
generate a cryptographic signature using the message digest and a private key of an entity asserting the compliance;
combine the message digest and cryptographic signature to create the digital compliance record.

13. The airworthiness certification system of claim 9 wherein the second network nodes are further configured to:
generate a new transaction block including the digital compliance record; and
cryptographically link the new transaction block with a previous transaction block in the distributed public ledger.

14. The airworthiness certification system of claim 13 wherein the second network nodes are further configured to:
generate a hash of the previous transaction block and the digital compliance record; and
record the hash in the new transaction block to cryptographically link the transaction block with a previous transaction block in the distributed public ledger.

15. The airworthiness certification system of claim 9 wherein the second network nodes are further configured to:
generate a new transaction block including the digital compliance record and a digital timestamp; and
cryptographically link the new transaction block with a previous transaction block in the distributed public ledger.

16. The airworthiness certification system of claim 15 wherein the second network nodes are further configured to:
generate a hash of the previous transaction block, the digital compliance record and the digital timestamp; and
record the hash in the new transaction block the transaction block with a previous transaction block in the distributed public ledger.

17. A method of recording compliance with regulatory requirements for airworthiness certification of an aircraft or aircraft part, said method comprising:
receiving a digital compliance record including certification data indicative of compliance with a regulatory requirement for airworthiness certification; and
recording the digital compliance record in a distributed public ledger containing a compliance history for the aircraft or aircraft part.

18. The method of claim 17 wherein recording the digital compliance record in the distributed public ledger comprises:
generating a new transaction block including the digital compliance record; and
cryptographically linking the new transaction block with a previous transaction block in the distributed public ledger.
